(19) United States
(12) Patent Application Publication
(10) Pub. No.: US 2026/0300875 A1
(43) Pub. Date: Oct. 1, 2026

(54) SYSTEMS AND METHODS FOR RISK PRIORITIZATION

(71) Applicant: Honeywell International Inc., Charlotte, NC (US)

(72) Inventors: Mitchell O'Brien, Tempe, AZ (US); Gauri Chaware, Atlanta, GA (US); Andrew Martin, Doraville, GA (US)

(73) Assignee: Honeywell International Inc., Charlotte, NC (US)

(21) Appl. No.: 19/089,991

(22) Filed: Mar. 25, 2025

(51) Int. Cl. G06Q 10/0635; G06Q 10/067

(52) U.S. Cl. CPC G06Q 10/0635; G06Q 10/067

(57) ABSTRACT

A system includes memory communicatively coupled to processor(s) configured to receive risk scenario data indicating relative risk between multiple training transactions in each of a plurality of scenarios, where the multiple training transactions are selected from a plurality of training transactions in a feature dataset. The at least one processor is further configured to determine, using risk models, predicted risk scenario data based on predicted risk scores for the multiple training transactions in each of the plurality of scenarios using initial scalar weights. The processor(s) are further configured to compare the risk scenario data with the predicted risk scenario data using a gradient-free optimizer. The processor(s) are further configured to determine adjusted scalar weights for the risk models based on the comparison. The processor(s) are further configured to prioritize a plurality of input transactions according to risk using the risk models with the adjusted scalar weights.

### BACKGROUND

Risk assessment systems (such as Continuous Assessment and Monitoring Systems (CAMS), are tools that may be used to monitor compliance and audit-related potential risks that could expose a business to monetary loss or other risks. It may be desirable to prioritize risks to enable limited resources to be allocated efficiently to ensure that the most critical risks are addressed promptly.

### SUMMARY

A system comprises at least one processor and at least one memory communicatively coupled to the at least one processor. The at least one memory stores computer readable instructions that when executed by the at least one processor causes the at least one processor to: receive risk scenario data indicating relative risk between multiple training transactions in each of a plurality of scenarios, the multiple training transactions selected from a plurality of training transactions in a feature dataset; determine, using risk models, predicted risk scenario data based on predicted risk scores for the multiple training transactions in each of the plurality of scenarios using initial scalar weights; compare the risk scenario data with the predicted risk scenario data using a gradient-free optimizer; determine adjusted scalar weights for the risk models based on the comparison; and prioritize a plurality of input transactions according to risk using the risk models with the adjusted scalar weights.

A method is also disclosed. The method includes receiving risk scenario data indicating relative risk between multiple training transactions in each of a plurality of scenarios. The multiple training transactions selected from a plurality of training transactions in a feature dataset. The method also includes determining, using risk models, predicted risk scenario data based on predicted risk scores for the multiple training transactions in each of the plurality of scenarios using initial scalar weights. The method also includes comparing the risk scenario data with the predicted risk scenario data using a gradient-free optimizer. The method also includes determining adjusted scalar weights for the risk models based on the comparison. The method also includes prioritizing a plurality of input transactions according to risk using the risk models with the adjusted scalar weights.

### BRIEF DESCRIPTION OF DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram illustrating an example system for risk prioritization;

FIG. 2 is a block diagram illustrating a method for determining a risk score;

FIG. 3 is a block diagram of an example user interface in which the stakeholder (or employee of the stakeholder) may determine labels for certain risk scenario data;

FIG. 4 is a block diagram illustrating a method for gradient-free optimization in the present systems and methods;

FIG. 5 is a block diagram illustrating a method for risk prioritization using gradient-free optimization; and

FIG. 6 is a block diagram illustrating example computing system(s).

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Risk assessment systems (such as Continuous Assessment and Monitoring Systems (CAMS)), are tools that may be used to monitor compliance and audit-related potential risks that could expose a business to monetary loss or other risks. Risk assessment systems cover a wide range of problems and may be particularly suited to identifying compliance and audit risks (e.g., financial risks, security risks, etc.). Typically, risk assessment systems generate different types of internal and external risk alerts for businesses to view and, if appropriate, act on.

Risk assessment systems may help ensure that a company's operations, processes, and financial transactions are in line with regulatory requirements and internal policies. This not only helps in maintaining the company's reputation, but also mitigates the risks associated with non-compliance. Unmitigated risk exposure can open a company to legal penalties and financial losses, sometimes in more than one jurisdiction. Sometimes risk assessment systems monitor such a wide range of alerts, prioritizing the risk alerts for a compliance and audit team becomes desirable for effective risk management and resource allocation. In examples, risk assessment systems may use advanced analytics and/or artificial intelligence to better prioritize risk.

The term “stakeholder” is used herein to refer to a person or a business (such as a small to medium enterprise (SME)) or other entity, e.g., that desires to prioritize risks it is exposed to. When referring to a business or entity, a stakeholder will typically have at least one (and likely multiple) employee(s), each with various duties, and may optionally operate in multiple jurisdictions. Thus, in examples, the specific person employed by the stakeholder using a risk assessment system may not have decision-making authority. Additionally, when a stakeholder is described as taking some action in the description below, it is understood that it may be a person taking action on behalf of the stakeholder.

One example use case of the present systems and methods relates to gifts and hospitality (G & H) expenses paid by a stakeholder. The stakeholder may provide corporate credit cards (and/or other access to petty cash or other payment means) for work-related expenses to their employees, e.g., for a meal with a customer. The stakeholder may want to understand which employee(s) potentially pose a high risk (e.g., bribery or other type of financial risk) based on their employee expense transaction data. Accordingly, employees may be asked to justify the use of the corporate credit card by entering details of each G & H transaction into an internal system, e.g., the cost of the transaction, the person or persons benefitting from the transaction, where was transaction made, what was the reason for the transaction, method(s) of payment (cash or card), etc. The stakeholder would be interested in identifying high-risk G & H transactions and may have a set of lists that they crosscheck the transaction data against. For example, if an employee always pays in cash (despite having a corporate credit card), those transactions may pose an elevated risk of fraud. Alternatively, if the transaction entered by the employee has no comments in the comments field (such as no explanation of purpose), the transaction may pose a relatively high risk. Alternatively, if a government official was in attendance, the transaction may pose a relatively high risk. Alternatively, if alcohol was purchased or consumed, the transaction may pose a relatively high risk. Furthermore, the specific country or city may contribute to relative risk level. Risk assessment systems (such as CAMS) provides a way to automatically determine whether transactions are considered risky or not, e.g., to numerically assess the relative risk of a transaction based on a number of factors.

Another example use case of the present systems and methods is procurement transactions. The stakeholder may resource different material from different vendors. The stakeholder will have different procurement/purchase orders and different risk factors that the stakeholder has identified. For example, if a vendor is splitting a single $100 purchase order into 10 purchase orders of $10 each, that may indicate possible fraud that may expose the stakeholder to legal liability. Alternatively, if a purchase order price is recorded as $0 it may indicate a higher risk than normal. Alternatively, if a vendor uses a public email address, the purchase order may be relatively high risk. Alternatively, if the vendor name on a purchase order for electronic equipment does not appear to be an electronics vendor, the purchase order may be relatively high risk. Thus, similar to gifts and hospitality examples, the present systems and methods may assess relative risk (e.g., numerically) of procurement transactions, albeit the risk factors monitored for procurement transactions may or may not differ from the risk factors monitored for G & H transactions.

Another example use case of the present systems and methods is diversion in which a stakeholder sells materials in a first country but those materials are diverted to another, higher-risk country. In some configurations, the present systems may enable the stakeholder to identify and prioritize diversion risk posed by different transactions, e.g., since some products may have restrictions on where they can be sold.

It should be noted that the present systems and methods may be used to prioritize any group of transactions against each other. Thus, while employee expense transactions (G & H transactions) may be discussed below, this is only one of many potential use cases for the present systems and methods. As long as risk factors and risk scenario data can be obtained (e.g., received from the stakeholder), the present systems and methods can be generalizable to many different use cases.

Prioritization of alerts from a risk assessment system can help to ensure that the most critical risks, such as those with the highest potential impact on the company's objectives or compliance obligations, are addressed promptly. By focusing efforts on these high-priority risks, a company can mitigate negative consequences more effectively to safeguard the company's reputation, assets, and stakeholders' interests. Furthermore, prioritization allows the team to allocate limited resources efficiently. In a dynamic business environment, compliance and audit teams often face constraints in terms of time, budget, and manpower. By prioritizing risk alerts, resources can be directed to where they are most needed, thus maximizing the effectiveness of risk management efforts. Moreover, prioritization of risk alerts facilitates clear communication and decision-making within the team and with relevant stakeholders. This ensures alignment on the most pressing issues and actions required. Overall, prioritizing risk alerts enables compliance and audit teams to focus on alerts that matter most while enhancing the organization's ability to proactively identify, assess, and address risks.

Conventionally, a stakeholder using a risk assessment system may receive several potential risk alerts (also known as anomalies) but may have a difficult time prioritizing all these alerts. In other words, it may be difficult and/or inefficient to determine which alerts should be given more attention and/or other resources. For example, when a user of a risk assessment system (e.g., stakeholder risk management employee) receives many alerts, it is difficult for them to prioritize which alerts need attention first and which alerts are not urgent. There is no conventional risk assessment system that correctly prioritizes these alerts for the respective user (e.g., an employee of a stakeholder) based on different risk factors (also referred to as “risk models” herein). A system that prioritizes the most critical alerts would be highly beneficial for stakeholders.

To address this shortcoming in risk assessment systems, the present systems and methods prioritize and order the risk alerts presented to the user. For example, the present systems and methods may determine (e.g., calculate) a risk score for each transaction (or group of transactions) that combines: (1) specific knowledge from the user (e.g., from a stakeholder) on how critical each individual risk model is; and (2) the interaction of other risk models to get a final combined risk score that accurately represents the risk exposure to the stakeholder.

More specifically, machine-learning can be applied to a wide range of data to prioritize risk, as described herein. Gradient-free optimization is a technique that searches through the parameter space without relying on gradient information and often optimizes for both performance and risk (robustness, uncertainty management) compared to gradient-based approaches that seek to optimize an objective function (deep learning, convex optimization, etc.). Gradient-free optimization may be well-suited to evaluate non-differentiable functions (where a derivative (or gradient) cannot be determined at every point due to large sudden changes in output) and is generally robust to the type of uncertainty that may be present in risk prioritization systems for which the present systems and methods may be used.

Specifically, in the present systems and methods, a gradient-free optimizer model may be used to fine-tune the actual model that creates the risk scores and assigns priority. Basically, the gradient-free optimizer adjusts weights used by the risk model so that predicted risk score(s) align and agrees with actual risk score(s) received from stakeholder(s). Therefore, while the gradient-free optimizer may not perform the prioritization itself, the gradient-free optimizer optimizes (e.g., fine tunes) the combination of scalar weights used by the risk model to generate the risk scores used for prioritization of risks.

The gradient-free optimizer learns stakeholder behaviors through a training process, e.g., that includes many iterations of guessing and evaluating the output of the guess (i.e., the loss or reward) for different parameter settings. The training process may include creating a feature dataset using risk models (different types of risks) from the stakeholder, each risk model having an associated priority (e.g., between 1-10). An example feature dataset is shown further below in Table 2, where each column is a risk model and each row is a transaction or behavior. A risk score may be calculated for each potential transaction or behavior in the feature dataset.

The training process may also include a stakeholder evaluating multiple risk scenarios, each scenario having two or more transactions or behaviors from the feature dataset. For each scenario, the stakeholder indicates which of the two or more transactions or behaviors in the scenario is the riskiest (the highest priority risk).

The gradient-free optimizer evaluates the same risk scenarios using the predicated risk scores discussed above (calculated using initial weights at first), compares the predicated risk scores to the actual stakeholder evaluations, and updates the scalar weights based on the comparisons. Through this training process, the gradient-free optimizer will optimize the scalar weights so that the predicted priority for a given scenario matches the actual priority from the stakeholder.

During runtime (post-training), the risk model (using scalar weights tuned by the gradient-free optimizer) receives input data with actual transactions and/or behaviors, then prioritizes (e.g., ranks) which actual transactions and/or behaviors in the input data pose the highest risk. The runtime prioritization is based on scalar weights refined during training, and thus mimics risk prioritization behavior of the stakeholder itself.

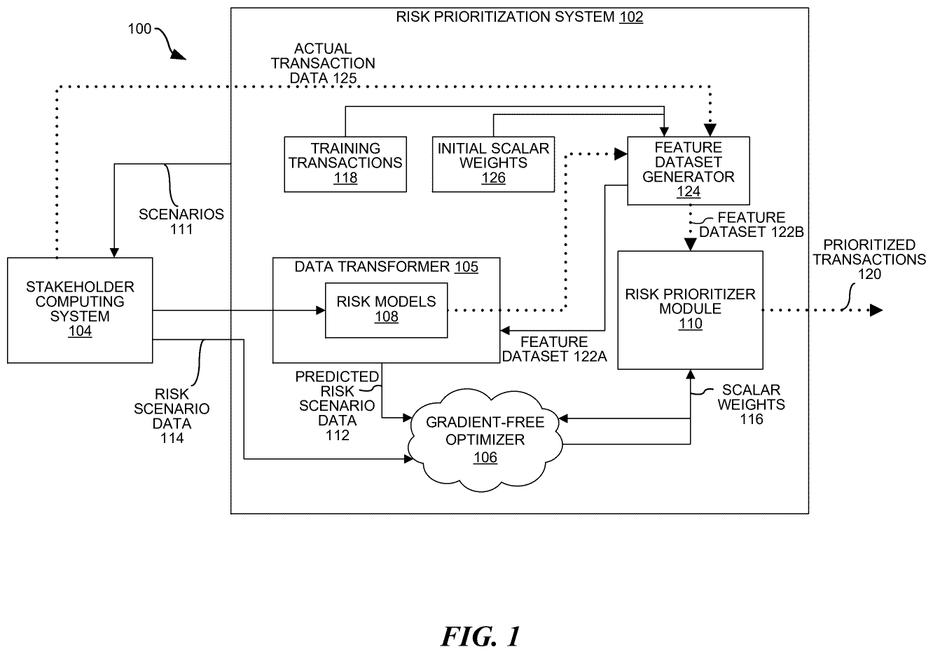

FIG. 1 is a block diagram illustrating a system 100 for risk prioritization. The system 100 may include at least one stakeholder computing system 104 and at least one risk prioritization system 102, each of which may include at least one respective processor executing instructions stored on at least one respective memory. The stakeholder computing system 104 may be run by a stakeholder that desires to prioritize risks (e.g., at the transaction level or at the employee level) it is exposed to. The risk prioritization system 102 may be run by the stakeholder or a separate entity. Each of the stakeholder computing system 104 and risk prioritization system 102 may be implemented as standalone computing devices or a series physical computing devices, and the functions thereof may optionally be implemented in a cloud computing environment with many computing devices.

Where the training environment is a local computing environment, processors and memory used for training may be implemented on one or more locally operating computers, such as workstations or servers. In some configurations, the gradient-free optimization described herein may be performed in a parallel-processing hardware architecture. For example, and without limitations, the risk prioritization system 102 may be implemented using one computing device(s) that may include one or more high-performance graphics processing units (GPUs), central processing units (CPUs), tensor processing units (TPUs), application-specific integrated circuit (ASICs), field-programmable gate arrays (FPGAs), and/or any other processing resources with architectures suitable to parallel processing.

However, local environments may be constrained in their processing capabilities. In contrast, where the training environment is a distributed system, the processors and memory used for training are implemented within multiple computing devices (like workstations and servers) distributed across one or more locations. Further, multiple computing devices often train models using parallel computation. These distributed processors and memory are often suitable for training models with larger datasets and complexity that gradient-free optimization may involve. GPUs may be particularly suitable (and available) to evaluate many candidate solutions in parallel for gradient-free optimization but a combination of different types of hardware may be used to implement the risk prioritization system 102. Additionally, the training environment may be a cloud-based platform. As used herein, a cloud-based platform may refer to a service provided through the cloud that offers scalable resources for the training and deploying of gradient-free optimizers 106. In a distributed configuration, a distributed network of nodes (e.g., a peer-to-peer network) may collectively optimize scalar weights in parallel. In some configurations, the risk prioritization system may be implemented on a computing device with as little as 8 GB RAM with 256 GB storage, although higher specifications may be desirable for larger data sets.

In certain embodiments, when training the gradient-free optimizer 106, processors may execute instructions that implement algorithms developed using a variety of programming languages and specialized libraries. For example, model developers may use programming languages such as Python, R, Java, C++, and MATLAB, which offer different benefits, e.g., Python supports many libraries that gradient-free optimization; R can be used to perform statistical analysis through libraries optimized for data exploration and modeling; Java is scalable. C++ enables low-level memory management; MATLAB is useful for prototyping and data visualization.

Generally, and without limitation, the solid lines between blocks in FIG. 1 represent initial training steps and the dotted lines between blocks in FIG. 1 represent post-training steps and/or updated training steps. Furthermore, the different blocks in FIG. 1 may be implemented in the same processor(s), access the same memory, and/or be communicatively coupled via one or more buses, bridges, controllers, adapters, and/or point-to-point connections.

In the present systems and methods, the stakeholder computing system(s) 104 and risk prioritization system(s) 102 may communicate during the training process and/or the post-training phase. This communication can be performed in any suitable way, e.g., HTTPS, FTP, via email, Short Message Service (SMS), Multimedia Messaging Service (MMS), instant messaging, push notification (such as a push verify notification), by polling (or pulling) a notification, or by Bluetooth, Wi-Fi, or near field communication (NFC) transmission.

The risk prioritization of the present systems and methods may be performed on demand in response to input from the stakeholder (e.g., via a user interface on a stakeholder computing system 104) and/or continuously or periodically in the background without direct input from the stakeholder.

### Training Process

As discussed herein, a gradient-free optimizer 106 may optimize scalar weights used by the risk prioritizer 110. Gradient-free optimization may be particularly well-suited to evaluating non-differentiable functions and/or noisy data sets. However, it is understood that any suitable large language models may be used instead of or in addition to a gradient-free optimizer 106, e.g., gradient-based solutions such as Stochastic Gradient Descent (SGD).

As an overview, gradient-free optimizers 106 determine optimal weights such that some metric is reached, e.g., accuracy between a predicted score and an actual score. For example, if (1) predicted risk scenario data 112 can be calculated by a data transformer 105 for training transactions 118 using risk models 108 (risk definitions) provided by the stakeholder (i.e., the stakeholder computing system 104) and initial scalar weights 126; and (2) actual risk scenario data 114 is received from the stakeholder indicating relative priority between different risks and combinations of risks; then the predicted risk scenario data 112 may be compared to the actual risk scenario data 114 to adjust the scalar weights 116 (by optimizing an accuracy metric between predicted risk scenario data 112 and actual risk scenario data 114). This iterative process can be performed until the predicted risk scenario data 112 is sufficiently close to the actual risk scenario data 114 from the stakeholder.

For example, the training can optionally be updated by using the adjusted scalar weights 116 from the initial training as the initial scalar weights 126 in subsequent training. One of the purposes of training is to optimize scalar weights 116 so they can be used when assessing risk during post-training operation, e.g., to prioritize risk among many different transactions (prioritized transactions 120). While the training is discussed herein as using training transactions 118, the training (e.g., optimizing scalar weights 116) could alternatively or additionally use actual transaction data 125.

The training process may include defining different types of risks, which may be referred to as “risk models” 108 herein. For example, the risk models 108 may represent the types of risks monitored for, and used to prioritize transactions, by the risk prioritization system 102. Generally, and without limitation, the risk models 108 would be defined by the stakeholder, e.g., the stakeholder may determine the risk models 108 based on pre-defined policies it currently uses. Additionally or alternatively, the risk prioritization system 102 may include a list of risk models 108 from which the stakeholder may select for inclusion when prioritizing its transactions.

Table 1 illustrates example risk models 108 that may be used for G & H financial transactions. Each row in Table 1 may represent a risk model 108 with an associated index, expected risk impact (e.g., high, medium, low), and a priority (e.g., between 1-10). Generally, each risk model 108 relates to a specific evaluation that resolves in a binary fashion (e.g., “0” or “1”) depending on whether the evaluation is false or true for a particular transaction, e.g., multivariate outcomes with more than two possible outcomes (e.g., “0”, “0.1”, “0.2”, etc.) may be possible but are not typically used. For example, each of the following risk models 108 in Table 1 resolves only to false or true (e.g., “0” or “1”) for a given financial transaction: Is amount in USD per person anomaly for country and expense type; Has a government official in attendance; Has no G & H approval code; Contains the keyword “government”; Is in a high risk country; Amount in USD is over $500; Has no comments; Has no business purpose; Was paid for in cash or non-corporate card; Is an entertainment expense; Does not have receipt; Is amount in USD anomaly for country and expense type; Contains the keyword “donation”; Contains the keyword “charity”; Contains the keyword “alcohol”; Contains the keyword “gift”; Is in a medium risk country; Contains the keyword “golf”; Contains the keyword “ticket”; Contains the keyword “relationship”; and Is in a low risk country. However, it is possible that multinomial risk models (with more than two possible outcomes) could also be used with the present systems and methods.

TABLE 1
Example Risk Models

| | | | Expected |
|---|---|---|---|
| | | Expected | Risk |
| | | Risk | Impact |
| Index | Risk Model 108 | Impact | Score |
| 1 | Is amount in USD per person anomaly | High | 10 |
| | for country and expense type | | |
| 2 | Has a government official in | High | 10 |
| | attendance | | |
| 3 | Has no G & H approval code | High | 10 |
| 4 | Contains the keyword “government” | High | 10 |
| 5 | Is in a high risk country | High | 9 |
| 6 | Amount in USD is over $500 | High | 8 |
| 7 | Has no comments | High | 8 |
| 8 | Has no business purpose | High | 8 |
| 9 | Was paid for in cash or non-corporate | High | 8 |
| | card | | |
| 10 | Is an entertainment expense | High | 7 |
| 11 | Does not have receipt | High | 7 |
| 12 | Is amount in USD anomaly for | Medium | 6 |
| | country and expense type | | |
| 13 | Contains the keyword “donation” | Medium | 6 |
| 14 | Contains the keyword “charity” | Medium | 6 |
| 15 | Contains the keyword “alcohol” | Medium | 5 |
| 16 | Contains the keyword “gift” | Medium | 5 |
| 17 | Is in a medium risk country | Medium | 5 |
| 18 | Contains the keyword “golf” | Low | 3 |
| 19 | Contains the keyword “ticket” | Low | 3 |
| 20 | Contains the keyword “relationship” | Low | 3 |
| 21 | Is in a low risk country | Low | 3 |

The expected risk impact in Table 1 may be defined by the stakeholder and the expected risk impact score may be determined by the stakeholder and/or another person or entity. It is understood that Table 1 is merely illustrative of the risk models, and the data could be structured in different and/or additional ways.

After the risk models 108 are determined or received at the risk prioritization system 102 (e.g., received from a stakeholder computing system 104), a feature dataset generator 124 may transform transactions (training transactions and/or actual transaction data 125) into a feature dataset 122A. Table 2 illustrates an example feature dataset 122A-B where each row represents a transaction each respective risk model 108 is represented by a different column. TransactionID and/or EmployeeID field(s) may optionally be included for each transaction in the feature dataset 122A-B.

It should be noted that the predicted risk scenario data 112 (that is compared to the risk scenario data 114 from the stakeholder in the gradient-free optimizer 106) may include a feature dataset 122A formed from training transactions 118. Thus, the predicted risk scenario data 112 and the risk scenario data 114 may both indicate which transaction in each scenario 111 is higher risk, but the predicted risk scenario data 112 is a prediction based on initial scalar weights 126 (and later adjusted scalar weights 116) and the actual risk scenario data 114 represents an explicit stakeholder selection by the stakeholder.

Each transaction (such as a specific charge on a stakeholder credit card, represented by a particular row in Table 2) in a feature dataset 122A-B may have a 1 or a 0 for each risk model 108 that it satisfies or does not satisfy. For example, with reference to Table 1, the transaction having TransactionID=1 would satisfy risk models 2 and 3, but not risk model 1. Conversely, the transaction having TransactionID=2 would satisfy risk model 1, but not risk models 2 and 3. Thus, using the exemplary risk models from Table 1 above, the first transaction (TransactionID=1) in Table 2: (1) has a government official in attendance (risk model 2); and (2) has no G & H approval code (risk model 3); but is not an anomalous amount in USD per person for the country and expense type of the transaction (risk model 1). Conversely, the second transaction (TransactionID=2) in Table 2: (1) is an anomalous amount in USD per person for the country and expense type of the transaction (risk model 1); but (2) does not have a government official in attendance (risk model 2); and (3) has a G & H approval code (risk model 3). The other example risk models from Table 1 are not shown explicitly in the example feature dataset 122A-B in Table 2, but it is understood that a feature dataset 122A-B would typically include a column for each risk model 108 received from and/or used by the stakeholder, e.g., Table 2 would have least 21 columns for the 21 risk models 108 in Table 1 (plus possible extra column(s) for optional TransactionID and/or Employee).

TABLE 2
Example Feature Dataset 122

| RiskModel_1 | RiskModel_2 | RiskModel_3 | . . . | TransactionID | EmployeeID |
|---|---|---|---|---|---|
| 0 | 1 | 1 | | 1 | E12345 |
| 1 | 0 | 0 | | 2 | E45678 |

. . .

| | | | | |
|---|---|---|---|---|
| 0 | 0 | 0 | 999 | E1111 |
| 1 | 0 | 1 | 1000 | E1111 |

A risk score may then be calculated for each transaction (each row in Table 2) in the feature dataset 122A-B. To determine a risk score for each transaction in the feature dataset 122A-B, randomized initial scalar weights 126 may be initialized for each of these columns (risk models 108), where the transaction value (which will typically be either “0” or “1” depending on whether the risk model 108 is satisfied) is multiplied with each risk model's initial scalar weight 126, then all the scaled values may be summed to get a risk score for that transaction (then the risk score may optionally be scaled again to produce normalized data). Since one of the goals of the present systems and methods is to correctly prioritizes the high risks first, the risk prioritization system 102 may compare any two transaction scenarios and correctly select the one that is riskier based on the calculated risk score for each transaction in the prioritized transactions 120. Table 3 illustrates example initial scalar weights 126 for each risk model 108 in Table 1.

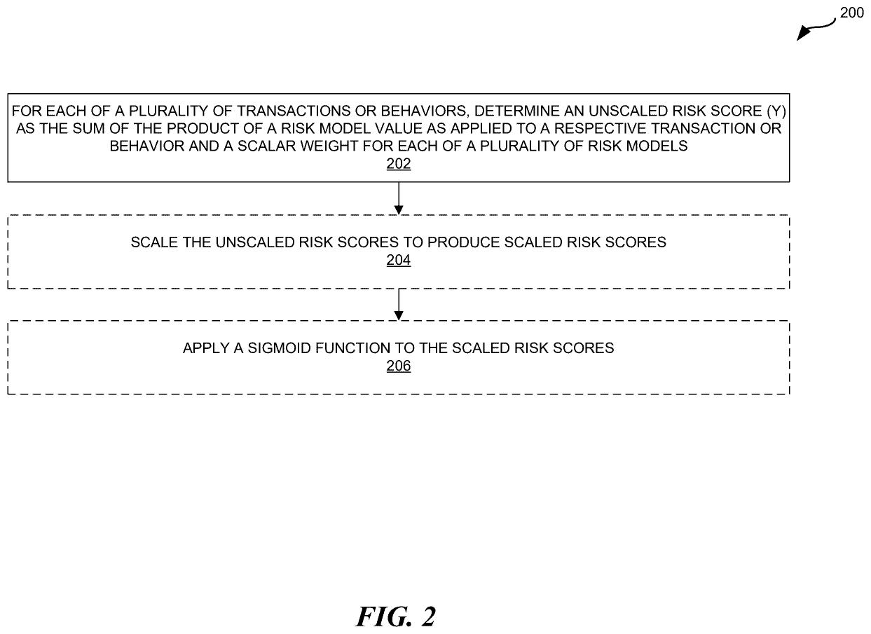

FIG. 2 is a block diagram illustrating a method 200 for determining a risk score. The method 200 may be implemented using at least one processor (e.g., GPU(s), CPU(s), TPU(s), ASIC(s), FPGA(s)) that implement the processing in a risk prioritization system 102, e.g., a risk prioritizer 110.

The method begins in step 202 when, for each of a plurality of transactions or behaviors, an unscaled risk score (Y) is determined as the sum of the product of a risk model value (X) as applied to a respective transaction or behavior and a scalar weight 126 (W) for each of a plurality of risk models 108. For example, the formula for determining an unscaled risk score for the first transaction may be Y1=(X1×W1)+(X2×W2)+(X3×Wn)+ . . . (Xn×Wn); where Y1 is the unscaled risk score for the first transaction; X1, X2, X3, Xn are the risk model values of the first, second, third, and nth risk models 108 as applied to the first transaction (e.g., each risk model value is “0” or “1” depending on whether the transaction satisfies the particular risk model 108); and W1, W2, W3, Wn are the initial scalar weights 126 for the first, second, third, and nth risk models (e.g., 1-10), respectively, e.g., from Table 3.

Referring only to the first three risk models 108 in Table 1 for brevity (as well as Tables 2 and 3), the unscaled risk score for the first transaction in Table 2 may be Y1=0×10+1×10+1×10=20. As a further example, the unscaled risk score for the second transaction in Table 2 may be Y2=1×10+0×10+0×10=10.

TABLE 3
Initial Scalar Weights 126

| | | Initial Scalar |
|---|---|---|
| Risk Model 108 | Category | Weight 126 |
| If_amount_in_USD per person anomaly for | High | 15 |
| country and expense type | | |
| Has a government official in attendance | High | 15 |
| Has no G & H approval code | High | 15 |
| Contains the keyword “government” | High | 15 |
| Is in a high risk country | High | 15 |
| Amount in USD is over $500 | High | 15 |
| Has no comments | High | 15 |
| Has no business purpose | High | 15 |
| Was paid for in cash or non-corporate card | High | 15 |
| Is an entertainment expense | High | 15 |
| Does not have receipt | High | 15 |
| Is amount in USD anomaly for country and | Medium | 5 |
| expense type | | |
| Contains the keyword “donation” | Medium | 5 |
| Contains the keyword “charity” | Medium | 5 |
| Contains the keyword “alcohol” | Medium | 5 |
| Contains the keyword “gift” | Medium | 5 |
| Is in a medium risk country | Medium | 5 |
| Contains the keyword “golf” | Low | 2 |
| Contains the keyword “ticket” | Low | 2 |
| Contains the keyword “relationship” | Low | 2 |
| Is in a low-risk country | Low | 2 |

The method 200 proceeds at optional step 204 where the unsealed risk scores (Y) may be scaled to produce scaled risk scores (Yscaled). For example, the scaled risk scores may be standardized or normalized so that the average of the scaled risk scores (Yscaled) is zero and the data is resized so standard deviations of the scaled risk scores (Yscaled) is 1 (or scaling them into a smaller range). The scaling may include subtracting the mean of the risk scores from the unscaled risk scores (to center the data around zero), then dividing by the standard deviation of the scaled risk scores (so the data has a standard deviation of 1 and it's normalized to a consistent scale). This process may be referred to as Z-score normalization or standardization.

The method 200 proceeds at optional step 206 where a sigmoid function may be applied to the scaled risk scores (Yscaled). Alternatively, if step 204 is not performed, step 206 may include applying the sigmoid functions to the unscaled risk scores (Y). The sigmoid function may ensure the sigmoid function's output (the final risk score (Y′)) is distributed more evenly between 0 and 1, which may produce more meaningful output, e.g., more differentiation between input values. When step 204 is performed, it may prevent over-compression of the subsequent sigmoid output values and loss of interpretability.

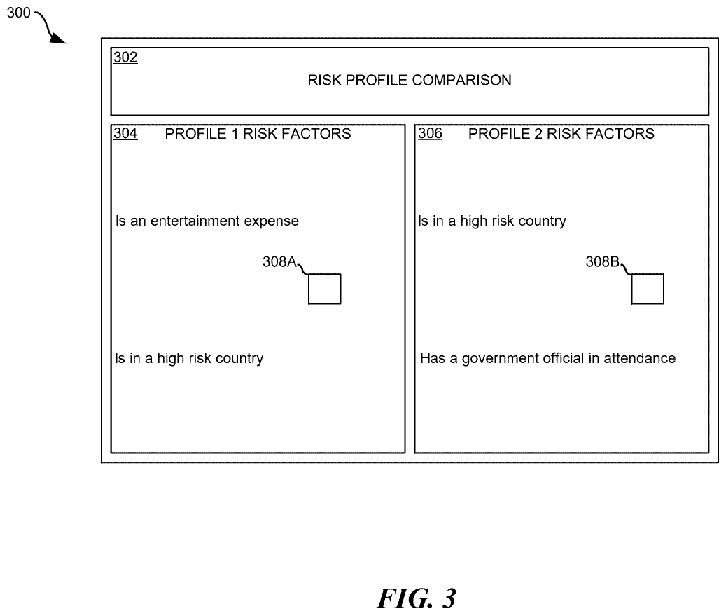

As mentioned above, the initial scalar weights 126 used may be randomized, but it may be desirable to optimize the scalar weights 116 in a way that would correctly give a higher risk score for riskier transactions and a lower risk score for low-risk transactions. Since labeled data may not exist for the initial model training, priority scale information that we have for all the risk models 108 (see Table 1) can be leveraged, e.g., labels such as “high”, “medium”, and “low” for different risk models 108. A sample of transaction scenarios 111 that includes different combinations of high, medium, and low risk models 108 can then be strategically generated. These samples may be presented as scenario comparisons to the stakeholder, who may be prompted to select the riskier combination of risk model, as described below in FIG. 3.

FIG. 3 is a block diagram of an example user interface 300 in which the stakeholder (or employee of the stakeholder) may determine labels for certain risk scenario data 114. The user interface 300 may include an optional header panel 302 and two or more sub-areas 304, 306, each with a different risk scenario. In FIG. 3, two sub-areas 304, 306 are illustrated, but it is understood that more than two risk scenarios may be displayed to the stakeholder at one time. Additionally, other user interfaces can be used to elicit stakeholder feedback in the present systems and methods.

In some configurations, the stakeholder may be prompted to select which of a first scenario in a first sub-area 304 (in which the transaction is an entertainment expense and is in a high risk country) and a second scenario in a sub-area 306 (in which the transaction is in a high risk country and has a government official in attendance) is more risky to the stakeholder, e.g., via an interactive element such as a checkbox 308A-B, text field, dropdown menu, radio button, toggle button, standard button, slide bar, etc. In other words, the stakeholder may be asked to identify which of multiple training transactions 118 (described in the two sub-areas 304, 306 in FIG. 3) is a higher priority risk. In examples, the stakeholder may be asked to choose the higher risk among multiple scenarios many times to produce the risk scenario data 114 that is eventually used by the gradient-free optimizer 106 to optimize scalar weights 116 to determine risk scores.

Once the labels for different scenario comparisons are received (e.g., as part of the risk scenario data 114), a gradient-free optimization technique may be used to test out different scalar weights 116 for each of the risk models 108. To guide the gradient-free optimizer 106, a specific scalar weight range may be provided for each of the risk models 108 to the gradient-free optimizer 106 and an accuracy metric may be used with the labeled sample set to optimize the scalar weights 116 for a given number of epochs. Once the scalar weights 116 have been optimized, the final risk scores for all the transactions can be calculated using these optimized scalar weights 116.

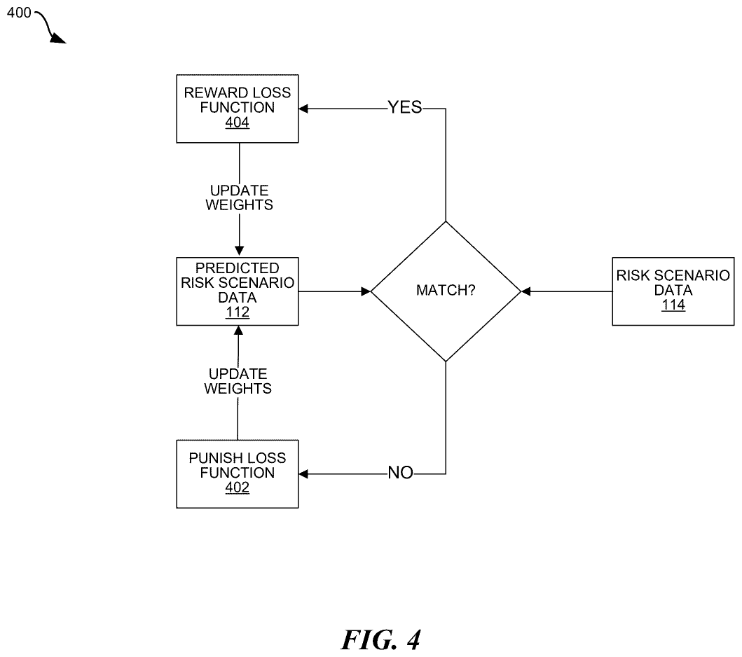

FIG. 4 is a block diagram illustrating a method 400 for gradient-free optimization in the present systems and methods. The method 400 may be an example implementation of the gradient-free optimizer 106 in a risk prioritization system 102 illustrated in FIG. 1, e.g., implemented using at least one memory and at least one processor, e.g., GPU(s), CPU(s), TPU(s), ASIC(s), FPGA(s), etc.

As discussed above, gradient-free optimization is an iterative process that seeks to optimize scalar weights 116 so that some metric is reached (e.g., accuracy between a predicted score and an actual score). In the present systems and methods, the metric is accuracy of predicted risk scenario data 112 (using risk models 108 and scalar weights) compared to actual risk scenario data 114 (received from the stakeholder selections as illustrated in FIG. 3).

Put another way, a loss function of gradient-free optimization is a mathematical way to measure how good or bad a particular prediction or solution is, e.g., the loss function tells indicates the cost of being wrong or the penalty for a poor decision. In FIG. 4 the loss function may be an accuracy metric (between a predicted score and an actual score). The gradient-free optimizer 106 will try to find a suitable set of scalar weights 116 that will increase the accuracy of the predicted risk scenario data 112 compared to the actual risk scenario data 114.

For any scenario with two transactions (e.g., financial transactions or behaviors), a predicted risk score may be calculated (predicted risk scenario data 112) after which the predicted risk scenario data 112 is compared to the stakeholder selection in actual risk scenario data 114 (e.g., the scenarios selected by the stakeholder) and the scalar weights 116 are adjusted based on the comparison, e.g., the punish loss function 402 updates the scalar weights 116 when the predicted does not match the actual or the reward loss function 404 updates the scalar weights 116 when the predicted matches the actual. In other words, the scalar weights 116 can be iterated until the predicted risk scenario data 112 is sufficiently close to the actual risk scenario data 114 from the stakeholder. Furthermore, the training can be updated by updated scalar weights 116 in subsequent training.

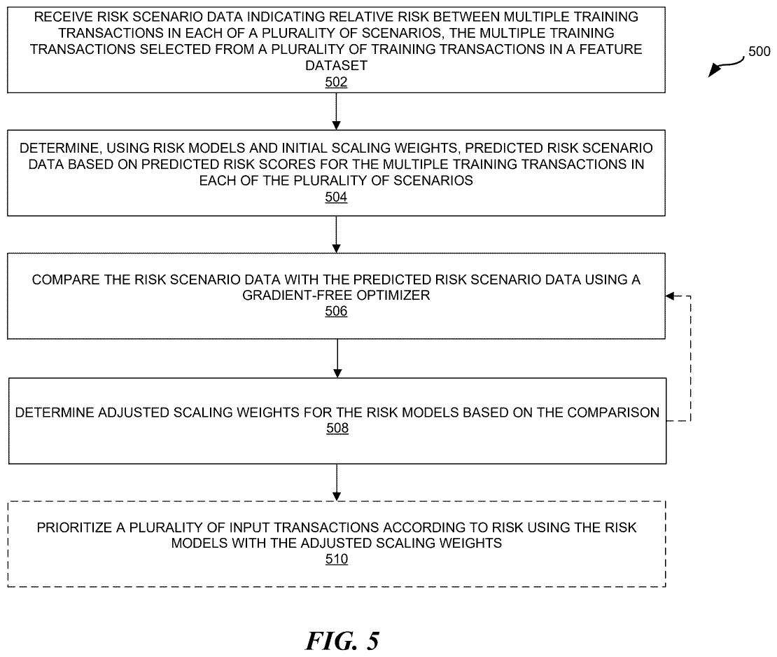

FIG. 5 is a block diagram illustrating a method 500 for risk prioritization using gradient-free optimization. The method 500 may be performed by a risk prioritization system 102, e.g., that is implemented using some combination of software and hardware. In examples, the example method 500 is embodied, at least in part, in a set of instructions on a non-transitory computer-readable medium including instructions, that when executed by at least one processor, cause the at least one processor to perform the functionality described in example method 500. In examples, the non-transitory computer-readable medium can be any device, mechanism, or populated data structure used for storing information, e.g., any type of volatile memory, nonvolatile memory, and/or dynamic memory, random access memory, memory storage devices, optical memory devices, magnetic media, floppy disks, magnetic tapes, hard drives, EPROMs, EEPROMs, optical media, disc drives, flash drives, etc.

Furthermore, and without limitation, the method 500 may be implemented using at least one processor, e.g., at least one graphics processing unit (GPU), at least one central processing units (CPUs), at least one tensor processing unit (TPU), at least one application-specific integrated circuit (ASIC), at least one field-programmable gate array (FPGA), and/or any other processing resources with architectures suitable to parallel processing. GPUs may be particularly suitable (and available) to evaluate many candidate solutions in parallel but a combination of different types of hardware may be used to implement the risk prioritization system 102. Additionally, since gradient-free optimization includes parallel processing, the method 500 may be performed in a distributed manner in which a distributed network of nodes (e.g., a peer-to-peer network) may collectively optimize scalar weights as described herein.

In a non-distributed configuration, a local computing environment, processors, and memory may implement the method 500 on one or more locally operating computers, such as workstations or servers. In a distributed configuration, the method 500 may be implemented within multiple computing devices (like workstations and servers) distributed across two or more locations, each with their own processor(s) and memory.

The method begins at step 502 where the risk prioritization system 102 may receive risk scenario data 114 indicating relative risk between multiple training transactions 118 in each of a plurality of scenarios 111, where the multiple training transactions 118 are selected from a plurality of training transactions 118 in a feature dataset 122.

Step 502 may include sending scenarios 111 to a stakeholder computing system 104 via a user interface 300 similar to FIG. 3. Any suitable configuration of the user interface 300 may be used to prompt a user (e.g., employee of the stakeholder) to select one of multiple hypothetical transactions, with risk factors displayed (e.g., risk models 108 such as “is an entertainment expense”, “is in a high risk country”, has a government official in attendance”), is higher risk. The user may be prompted to use an interactive element for indicating their selection, e.g., checkbox 308A-B, text field, dropdown menu, radio button, toggle button, standard button, slide bar, etc.

The user may be prompted to iteratively make a selection for many different scenarios 111 to produce the risk scenario data 114 that is eventually used by the gradient-free optimizer 106 to optimize scalar weights 116 to determine risk scores.

The risk models 108 may define different types of risks being monitored for by the risk prioritization system 102, and may be used during transaction prioritization following training. Generally, and without limitation, the risk models would be defined by the stakeholder, e.g., the stakeholder may determine the risk models 108 based on pre-defined policies it currently uses and/or the risk prioritization system 102 may include a list of risk models 108 from which the stakeholder may select for inclusion when prioritizing its transactions. In some configurations, the risk models 108 are updated as risk management priorities change at the stakeholder.

Without limitation, Table 1 illustrates example risk models 108 that may be used for G & H financial transactions. Each risk model 108 may relate to a specific evaluation that resolves in a binary fashion (e.g., “0” or “1”) depending on whether the evaluation is false or true for a particular transaction, e.g., not multivariate with more than two possible outcomes (e.g., “0”, “0.1”, “0.2”, etc.). Without limitation, some examples of risk models 108 include: Is amount in USD per person anomaly for country and expense type; Has a government official in attendance; Has no G & H approval code; Contains the keyword “government”; Is in a high risk country; Amount in USD is over $500; Has no comments; Has no business purpose; Was paid for in cash or non-corporate card; Is an entertainment expense; Does not have receipt; etc.

The method proceeds at step 504 where the risk prioritization system 102 may determine, using risk models 108 and initial scalar weights 126, predicted risk scenario data 112 based on predicted risk scores for the multiple training transactions 118 (or actual transactions if actual transaction data 125 was used in training) in each of the plurality of scenarios 111. In some configurations, step 504 includes generating a feature dataset 122A, e.g., using the training transactions 118, risk models 108, and initial scalar weights 126. However, it is understood that the predicted risk scenario data 112 may take any suitable form as long as it indicates a predicted highest-risk transaction for at least one of the scenarios 111 sent to the stakeholder computing system 104. If a feature dataset 122A is used in the predicted risk scenario data 112, a risk score may be calculated for each transaction in it as follows.

In some configurations, step 504 may include: (1) determining an unscaled risk score for the mth transaction may be Ym=(X1×W1)+(X2×W2)+(X3×Wn)+ . . . (Xn×Wn); where Ym is the unscaled risk score for the mth transaction; X1 . . . Xn are the risk model values of the first, second, third, and nth risk models 108 as applied to the particular transaction (e.g., each risk model value is “0” or “1” depending on whether the transaction satisfies the particular risk model 108); W1, W2, W3, Wn are the initial scalar weights 126 for the first, second, third, and nth risk models (e.g., 1-10), respectively, e.g., from Table 3; (2) optionally scaling the unscaled risk scores (Y) to produce scaled risk scores (Yscaled), e.g., so that the average of the scaled risk scores (Yscaled) is zero and resizes the data so standard deviations of the scaled risk scores (Yscaled) is 1 (or scaling them into a smaller range); and (3) optionally applying a sigmoid function to the scaled risk scores (Yscaled) to ensure the sigmoid function's output (the final risk score (Y′) is distributed more evenly between 0 and 1 with more differentiation between input values (alternatively, the sigmoid function may be applied to the unscaled risk scores (Y)).

The method proceeds at step 506 where the risk prioritization system 102 may compare the risk scenario data 114 with the predicted risk scenario data 112 using a gradient-free optimizer 106, e.g., each selection of each scenario 111 in the risk scenario data 114 may be compared with the corresponding predicted selection (based on risk scores) in the predicted risk scenario data 112 (the risk scenario data 114 and the predicted risk scenario data 112 may include the same scenarios 111).

Gradient-free optimization is an iterative process that seeks to optimize scalar weights 116 so that some metric is reached (e.g., accuracy between a predicted score and an actual score). In the present systems and methods, the metric is accuracy of predicted risk scenario data 112 (using risk models 108 and scalar weights 116) compared to actual risk scenario data 114. Gradient-free optimization may be well-suited to evaluate non-differentiable functions (where a derivative (or gradient) cannot be determined at every point due to large sudden changes in output) and is generally robust to the type of uncertainty that may be present in risk prioritization of different transactions and behaviors, however, other solutions may be used instead of or in addition to a gradient-free optimizer 106, e.g., gradient-based solutions such as Stochastic Gradient Descent (SGD).

The method proceeds at step 508 where the risk prioritization system 102 may determine adjusted scalar weights 116 for the risk models 108 based on the comparison in step 506. A loss function of a gradient-free optimizer 106 is a mathematical way to measure how good or bad a particular prediction or solution is. In the method 500, the loss function may be an accuracy metric between the predicted risk scenario data 112 compared to the actual risk scenario data 114, e.g., the gradient-free optimizer 106 will try to find a suitable set of scalar weights 116 that will increase the accuracy of the comparison as outlined in FIG. 4.

Specifically, the scalar weights 116 may be adjusted based on the comparison between the predicted risk scenario data 112 compared to the actual risk scenario data 114 as follows: (1) the punish loss function 402 updates the scalar weights 116 when the predicted risk scenario data 112 does not match the actual risk scenario data 114; or (2) the reward loss function 404 updates the scalar weights 116 when the predicted risk scenario data 112 matches the actual risk scenario data 114.

Thus, the scalar weights 116 can be iteratively adjusted until the predicted risk scenario data 112 is sufficiently close to the actual risk scenario data 114 from the stakeholder. Accordingly, the updated weights can optionally be used to determine new predicted risk scenario data 112, which is compared to the actual risk scenario data 114 and used to adjust the adjusted scalar weights, and so on until the predicted risk scenario data 112 sufficiently matches the actual risk scenario data 114. What constitutes a sufficient match may be configurable. But in the example of a scenario with two different transactions, a sufficient match may mean that the predicted risk scenario data 112 predicts the same transaction as the higher risk as in the actual risk scenario data 114 from the stakeholder.

It should be noted that steps 506 and 508 may both be performed during “gradient-free optimization” but have been listed as two separate steps for illustrative purposes. However, it is understood that the comparison of predicted vs actual and adjustment of scalar weights 116 in the method 500 may be tightly integrated and/or not necessarily separable in some implementations of gradient-free optimization.

The method proceeds at optional step 510 where the risk prioritization system 102 may prioritize a plurality of input transactions according to risk using the risk models 108 with the adjusted scalar weights 116, e.g., the output of steps 506-508 performed one or more times.

In one configuration, step 510 may include prioritizing gifts and hospitality (G & H) expenses paid by a stakeholder business. Before step 510 is performed, the stakeholder may provide actual transaction data 125 in the form of corporate credit card records, petty cash records, and/or other payment records for work-related expenses authorized by employees of the stakeholder, e.g., for a meal with a customer. The actual transaction data 125 may be entered in a user interface on a computing device (e.g., a stakeholder computing system that interacts with a local executable program and/or a web app/web portal) where a series of questions are asked that correspond to the risk models 108 used by the stakeholder. With reference to Table 1 for example, the employee entering the transaction data may be asked to indicate the USD amount, whether a government official was in attendance, what is the G & H code for the transaction, to provide a text description of the reason, country of transaction, etc. Some of the questions may require some further interpretation to determine whether the transaction satisfies a particular risk model 108, e.g., the employee may be asked the USD amount, which may be subsequently autonomously compared a country and expense-type specific threshold to determine whether the amount in USD per person (entered by the employee) is anomalous for country and expense type per risk model 1 108.

Once the scalar weights 116 have been optimized (e.g., the output of steps 506-508 performed one or more times), a feature dataset 122B can be determined and risk scores calculated for each transaction in the feature dataset 122B using the optimized scalar weights 116 in the risk prioritizer 110. Then, a list of prioritized transactions 120 can be output from the risk prioritizer 110 and optionally sent to the stakeholder computing system 104. The list of prioritized transactions 120 can be presented in a way that clearly indicates the most critical transactions, e.g., using sound, color (e.g., red for urgent, etc.), animation (e.g., flashing for urgent), etc.

Additionally, various aggregation metrics based on the transaction-level risk scores can optionally be generated. For example, the stakeholder may want to understand which employee(s) potentially pose a high risk (e.g., bribery or other type of financial risk) based on their employee expense transaction data. Accordingly, the risk scores for an employee can be combined as a mean or sum of the transaction-level risk scores for the employee's transactions to obtain an employee risk score. Employee risk scores can optionally be compared against each other. As a result, the prioritized transactions 120 can additionally or alternatively be a list of employees sorted by the highest employee risk score, which allows the stakeholder to take swift corrective actions on the highest-risk employee(s) first.

Furthermore, an additional column could optionally be added to the feature dataset 122B to include, for example, business unit and business unit risk scores could be determined for each stakeholder business unit based on the employees assigned to each business unit. Business unit risk scores could be compared against each other to enable the stakeholder to identify the highest-risk business unit. Similarly, an additional column could optionally be added to the feature dataset 122B to include, for example, an employee location code and location risk scores could be determined for each stakeholder location based on the employees assigned to that location. Location risk scores could be compared against each other to enable the stakeholder to identify the stakeholder location with the highest risk.

In another configuration, step 510 may include prioritizing procurement transactions paid by a stakeholder in which each transaction that is ultimately prioritized may represent a different procurement/purchase order. In such an example, the individual procurement/purchase orders may be prioritized by transaction-level risk scores that are based on risk models 108 tailored for the procurement context. Additionally or alternatively, a vendor risk score could be determined by aggregating (e.g., combined as a mean or sum of) the transaction-level risk scores for the vendor's procurement/purchase orders. Vendor risk scores could be compared against each other to enable the stakeholder to identify the vendor(s) that pose the highest risk.

In yet another configuration, step 510 may include prioritizing diversion transactions in which the stakeholder sells materials in a first country, but those materials are diverted to another country that may be higher risk (and in which the materials may be restricted). In such a configuration, each transaction that is ultimately prioritized may represent a different diversion transaction. In such an example, the individual diversion transactions may be prioritized by transaction-level risk scores that are based on risk models 108 tailored for the diversion context. Additionally or alternatively, a buyer risk score could be determined by aggregating (e.g., combined as a mean or sum of) the transaction-level risk scores for the buyer's diversion transactions. Buyer risk scores could be compared against each other to enable the stakeholder to identify the buyer(s) that pose the highest risk.

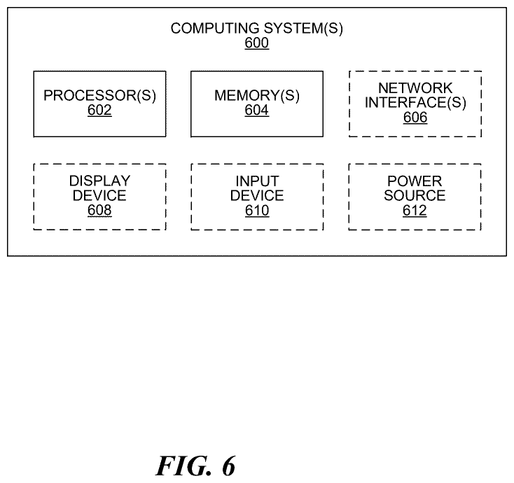

FIG. 6 is a block diagram illustrating example computing system(s) 600. The computing system(s) 600 includes at least one processor 602, at least one memory 604, optional at least one network interface 606, optional at least one display device 608, optional at least one input device 610, and optional at least one power source 612. In examples, any of the functionality disclosed herein may be implemented (at least in part) by the at least one processor 602 and the at least one memory 604. In examples, any of the stakeholder computing system 104 and/or risk prioritization system 102 can be implemented (at least in part) using the computing system(s) 600.

The at least one processor 602 can be any known processor, such as a general-purpose processor (GPP) or special purpose (such as a field-programmable gate array (FPGA), application-specific integrated circuit (ASIC) or other integrated circuit or circuitry), any programmable logic device, or any circuitry. In examples, the at least one memory 604 can be any device, mechanism, or populated data structure used for storing information. In examples, the at least one memory 604 can be or include any type of volatile memory, nonvolatile memory, and/or dynamic memory. In examples, the at least one memory 604 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 604 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information, which can be used as the at least one memory 604. The at least one memory 604 may be used to store instructions for running one or more applications or modules on the at least one processor 602. In examples, the at least one memory 604 could be used in one or more examples to house all or some of the instructions needed to execute the functionality discussed herein.

In examples, the optional at least one network interface 606 includes or is coupled to optional at least one antenna for communication with a network. In examples, the optional at least one network interface 606 includes at least one of an Ethernet interface, a cellular radio access technology (RAT) radio, a Wi-Fi radio, a Bluetooth radio, or a near field communication (NFC) radio. In examples, the optional at least one network interface 606 includes a cellular radio access technology radio configured to establish a cellular data connection (mobile Internet) of sufficient speeds with a remote server using a local area network (LAN) or a wide area network (WAN). In examples, the cellular radio access technology includes at least one of Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. or other appropriate communication services or a combination thereof. In examples, the optional at least one network interface 606 includes a Wi-Fi (IEEE 802.11) radio configured to communicate with a wireless local area network that communicates with the remote server, rather than a wide area network. In examples, the optional at least one network interface 606 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device.

In examples, the optional at least one display device 608 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), or a plasma display. In examples, the optional at least one input device 610 includes at least one of a touchscreen (including capacitive and resistive touchscreens), a touchpad, a capacitive button, a mechanical button, a switch, a dial, a keyboard, a mouse, a camera, a biometric sensor/scanner, a microphone, etc. In examples, the optional at least one display device 608 is combined with the optional at least one input device 610 into a human machine interface (HMI) for user interaction with the computing system(s) 600. In examples, optional at least one power source 612 is used to provide power to the various components of the computing system(s) 600.

The methods and techniques described herein may be implemented in digital electronic circuitry, or with a programmable processor (for example, a special-purpose processor or a general-purpose processor such as a computer) firmware, software, or in various combinations of each. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory and storage media, including by way of example random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs), magneto-optical disks, and/or the like. Any of the foregoing may be supplemented by, or incorporated in, any known processor, such as a general purpose processor (GPP) or special purpose (such as a field-programmable gate array (FPGA), application-specific integrated circuit (ASIC) or other integrated circuit or circuitry), or any programmable logic device.

The components described above are meant to exemplify some types of possibilities. In no way should the aforementioned examples limit the disclosure, as they are only exemplary embodiments. The embodiments, structure, methods, etc. described herein, including those below and above, can be combined together in various ways.

### Terminology

Brief definitions of terms, abbreviations, and phrases used throughout this application are given below.

The terms “connected”, “coupled”, and “communicatively coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The phrases “in exemplary embodiments”, “in example embodiments”, “in some embodiments”, “according to some embodiments”, “in the embodiments shown”, “in other embodiments”, “embodiments”, “in examples”, “examples”, “in some examples”, “some examples” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

### EXAMPLE EMBODIMENTS

Example 1 includes a system, comprising: at least one processor; and at least one memory communicatively coupled to the at least one processor, the at least one memory storing computer readable instructions that when executed by the at least one processor causes the at least one processor to: receive risk scenario data indicating relative risk between multiple training transactions in each of a plurality of scenarios, the multiple training transactions selected from a plurality of training transactions in a feature dataset; determine, using risk models, predicted risk scenario data based on predicted risk scores for the multiple training transactions in each of the plurality of scenarios using initial scalar weights; compare the risk scenario data with the predicted risk scenario data using a gradient-free optimizer; determine adjusted scalar weights for the risk models based on the comparison; and prioritize a plurality of input transactions according to risk using the risk models with the adjusted scalar weights.

Example 2 includes the system of Example 1, wherein the computer readable instructions, when executed by the at least one processor, further causes the at least one processor to determine the predicted risk scenario data by: determining the feature dataset based on the plurality of training transactions, the risk models, and the initial scalar weights.

Example 3 includes the system of Example 2, wherein the computer readable instructions, when executed by the at least one processor, further causes the at least one processor to determine the predicted risk scenario data by: determining the predicted risk scores for each of the plurality of training transactions in the feature dataset based on a numerical priority of each of the risk models.

Example 4 includes the system of any of Examples 1-3, wherein the computer readable instructions, when executed by the at least one processor, further causes the at least one processor to generate the feature dataset using the risk models and the multiple training transactions, wherein each row in the feature dataset represents one of the multiple training transactions and each column in the feature dataset represents one of the risk models.

Example 5 includes the system of any of Examples 1-4, wherein the computer readable instructions, when executed by the at least one processor, further causes the at least one processor to determine risk scores by: for each of the plurality of training transactions, determine an unscaled risk score as a sum of a product of a risk model value as applied to a respective training transaction for each of a plurality of risk models.

Example 6 includes the system of Example 5, wherein the computer readable instructions, when executed by the at least one processor, further causes the at least one processor to determine the predicted risk scenario data by: scaling the risk scores to produce scaled risk scores such that an average of the scaled risk scores is zero and a standard deviation of the scaled risk scores is Example 1.

Example 7 includes the system of any of Examples 1-6, wherein the computer readable instructions, when executed by the at least one processor, further causes the at least one processor to determine the adjusted scalar weights by: for each scenario in the risk scenario data with the predicted risk scenario data, compare a selection in the risk scenario data with a corresponding predicted selection in the predicted risk scenario data.

Example 8 includes the system of any of Examples 1-7, wherein the computer readable instructions, when executed by the at least one processor, further causes the at least one processor to prioritize the plurality of input transactions by: determining a risk score for each of the plurality of input transactions and sort a list of the plurality of input transactions according to their respective risk score.

Example 9 includes the system of any of Examples 1-8, wherein the computer readable instructions, when executed by the at least one processor, further causes the at least one processor to prioritize the plurality of input transactions by: for each of multiple employees, combining multiple risk scores for multiple input transactions for the respective employee by taking a mean or sum of transaction-level risk scores for the multiple input transactions to determine a respective employee risk score; and comparing the employee risk scores for the multiple employees.

Example 10 includes the system of any of Examples 1-9, wherein the computer readable instructions, when executed by the at least one processor, further causes the at least one processor to receive the risk models from a stakeholder computing device, each risk model defining a particular risk to monitor for.

Example 11 includes a method, comprising: receiving risk scenario data indicating relative risk between multiple training transactions in each of a plurality of scenarios, the multiple training transactions selected from a plurality of training transactions in a feature dataset; determining, using risk models, predicted risk scenario data based on predicted risk scores for the multiple training transactions in each of the plurality of scenarios using initial scalar weights; comparing the risk scenario data with the predicted risk scenario data using a gradient-free optimizer; determining adjusted scalar weights for the risk models based on the comparison; and prioritizing a plurality of input transactions according to risk using the risk models with the adjusted scalar weights.

Example 12 includes the method of Example 11, wherein determining the predicted risk scenario data comprises determining the feature dataset based on the plurality of training transactions, the risk models, and the initial scalar weights.

Example 13 includes the method of Example 12, wherein determining the predicted risk scenario data comprises determining the predicted risk scores for each of the plurality of training transactions in the feature dataset based on a numerical priority of each of the risk models.

Example 14 includes the method of any of Examples 11-13, further comprising generating the feature dataset using the risk models and the multiple training transactions, wherein each row in the feature dataset represents one of the multiple training transactions and each column in the feature dataset represents one of the risk models.

Example 15 includes the method of any of Examples 11-14, further comprising determining risk scores by: for each of the plurality of training transactions, determining an unscaled risk score as a sum of a product of a risk model value as applied to a respective training transaction for each of a plurality of risk models.

Example 16 includes the method of Example 15, wherein determining the risk scores further comprises: scaling the risk scores to produce scaled risk scores such that an average of the scaled risk scores is zero and a standard deviation of the scaled risk scores is Example 1.

Example 17 includes the method of any of Examples 11-16, wherein determining the adjusted scalar weights comprises: for each scenario in the risk scenario data with the predicted risk scenario data, comparing a selection in the risk scenario data with a corresponding predicted selection in the predicted risk scenario data.

Example 18 includes the method of any of Examples 11-17, wherein prioritizing the plurality of input transactions comprises: determining a risk score for each of the plurality of input transactions and sort a list of the plurality of input transactions according to their respective risk score.

Example 19 includes the method of any of Examples 11-18, wherein prioritizing the plurality of input transactions comprises: for each of multiple employees, combining multiple risk scores for multiple input transactions for the respective employee by taking a mean or sum of transaction-level risk scores for the multiple input transactions to determine a respective employee risk score; and comparing the employee risk scores for the multiple employees.

Example 20 includes a non-transitory computer-readable medium including a set of instructions that, when executed by at least one processor, cause the at least one processor to: receive risk scenario data indicating relative risk between multiple training transactions in each of a plurality of scenarios, the multiple training transactions selected from a plurality of training transactions in a feature dataset; determine, using risk models, predicted risk scenario data based on predicted risk scores for the multiple training transactions in each of the plurality of scenarios using initial scalar weights; compare the risk scenario data with the predicted risk scenario data using a gradient-free optimizer; determine adjusted scalar weights for the risk models based on the comparison; and prioritize a plurality of input transactions according to risk using the risk models with the adjusted scalar weights.

What is claimed is:

1. A system, comprising:
at least one processor; and
at least one memory communicatively coupled to the at least one processor, the at least one memory storing computer readable instructions that when executed by the at least one processor causes the at least one processor to:
receive risk scenario data indicating relative risk between multiple training transactions in each of a plurality of scenarios, the multiple training transactions selected from a plurality of training transactions in a feature dataset;
determine, using risk models, predicted risk scenario data based on predicted risk scores for the multiple training transactions in each of the plurality of scenarios using initial scalar weights;
compare the risk scenario data with the predicted risk scenario data using a gradient-free optimizer;
determine adjusted scalar weights for the risk models based on the comparison; and
prioritize a plurality of input transactions according to risk using the risk models with the adjusted scalar weights.

2. The system of claim 1, wherein the computer readable instructions, when executed by the at least one processor, further causes the at least one processor to determine the predicted risk scenario data by:
determining the feature dataset based on the plurality of training transactions, the risk models, and the initial scalar weights.

3. The system of claim 2, wherein the computer readable instructions, when executed by the at least one processor, further causes the at least one processor to determine the predicted risk scenario data by:
determining the predicted risk scores for each of the plurality of training transactions in the feature dataset based on a numerical priority of each of the risk models.

4. The system of claim 1, wherein the computer readable instructions, when executed by the at least one processor, further causes the at least one processor to generate the feature dataset using the risk models and the multiple training transactions, wherein each row in the feature dataset represents one of the multiple training transactions and each column in the feature dataset represents one of the risk models.

5. The system of claim 1, wherein the computer readable instructions, when executed by the at least one processor, further causes the at least one processor to determine risk scores by:
for each of the plurality of training transactions, determine an unscaled risk score as a sum of a product of a risk model value as applied to a respective training transaction for each of a plurality of risk models.

6. The system of claim 5, wherein the computer readable instructions, when executed by the at least one processor, further causes the at least one processor to determine the predicted risk scenario data by:
scaling the risk scores to produce scaled risk scores such that an average of the scaled risk scores is zero and a standard deviation of the scaled risk scores is 1.

7. The system of claim 1, wherein the computer readable instructions, when executed by the at least one processor, further causes the at least one processor to determine the adjusted scalar weights by:
for each scenario in the risk scenario data with the predicted risk scenario data, compare a selection in the risk scenario data with a corresponding predicted selection in the predicted risk scenario data.

8. The system of claim 1, wherein the computer readable instructions, when executed by the at least one processor, further causes the at least one processor to prioritize the plurality of input transactions by:
determining a risk score for each of the plurality of input transactions and sort a list of the plurality of input transactions according to their respective risk score.

9. The system of claim 1, wherein the computer readable instructions, when executed by the at least one processor, further causes the at least one processor to prioritize the plurality of input transactions by:
for each of multiple employees, combining multiple risk scores for multiple input transactions for the respective employee by taking a mean or sum of transaction-level risk scores for the multiple input transactions to determine a respective employee risk score; and
comparing the employee risk scores for the multiple employees.

10. The system of claim 1, wherein the computer readable instructions, when executed by the at least one processor, further causes the at least one processor to receive the risk models from a stakeholder computing device, each risk model defining a particular risk to monitor for.

11. A method, comprising:
receiving risk scenario data indicating relative risk between multiple training transactions in each of a plurality of scenarios, the multiple training transactions selected from a plurality of training transactions in a feature dataset;
determining, using risk models, predicted risk scenario data based on predicted risk scores for the multiple training transactions in each of the plurality of scenarios using initial scalar weights;
comparing the risk scenario data with the predicted risk scenario data using a gradient-free optimizer;
determining adjusted scalar weights for the risk models based on the comparison; and
prioritizing a plurality of input transactions according to risk using the risk models with the adjusted scalar weights.

12. The method of claim 11, wherein determining the predicted risk scenario data comprises determining the feature dataset based on the plurality of training transactions, the risk models, and the initial scalar weights.

13. The method of claim 12, wherein determining the predicted risk scenario data comprises determining the predicted risk scores for each of the plurality of training transactions in the feature dataset based on a numerical priority of each of the risk models.

14. The method of claim 11, further comprising generating the feature dataset using the risk models and the multiple training transactions, wherein each row in the feature dataset represents one of the multiple training transactions and each column in the feature dataset represents one of the risk models.

15. The method of claim 11, further comprising determining risk scores by:
for each of the plurality of training transactions, determining an unscaled risk score as a sum of a product of a risk model value as applied to a respective training transaction for each of a plurality of risk models.

16. The method of claim 15, wherein determining the risk scores further comprises:
scaling the risk scores to produce scaled risk scores such that an average of the scaled risk scores is zero and a standard deviation of the scaled risk scores is 1.

17. The method of claim 11, wherein determining the adjusted scalar weights comprises:
for each scenario in the risk scenario data with the predicted risk scenario data, comparing a selection in the risk scenario data with a corresponding predicted selection in the predicted risk scenario data.

18. The method of claim 11, wherein prioritizing the plurality of input transactions comprises:
determining a risk score for each of the plurality of input transactions and sort a list of the plurality of input transactions according to their respective risk score.

19. The method of claim 11, wherein prioritizing the plurality of input transactions comprises:
for each of multiple employees, combining multiple risk scores for multiple input transactions for the respective employee by taking a mean or sum of transaction-level risk scores for the multiple input transactions to determine a respective employee risk score; and
comparing the employee risk scores for the multiple employees.

20. A non-transitory computer-readable medium including a set of instructions that, when executed by at least one processor, cause the at least one processor to:
receive risk scenario data indicating relative risk between multiple training transactions in each of a plurality of scenarios, the multiple training transactions selected from a plurality of training transactions in a feature dataset;
determine, using risk models, predicted risk scenario data based on predicted risk scores for the multiple training transactions in each of the plurality of scenarios using initial scalar weights;
compare the risk scenario data with the predicted risk scenario data using a gradient-free optimizer;
determine adjusted scalar weights for the risk models based on the comparison; and
prioritize a plurality of input transactions according to risk using the risk models with the adjusted scalar weights.
